(19) United States
(12) Patent Application Publication
(10) Pub. No.: US 2012/0057541 A1
(43) Pub. Date: Mar. 8, 2012

(54) METHOD AND APPARATUS FOR SCHEDULING IN WIRELESS COMMUNICATION SYSTEM USING DUAL CELL

(75) Inventors: Eun-Ho Choi, Seoul (KR); Tai-Suk Kim, Seoul (KR); Dae-Kwon Jung, Suwon-si (KR)

(73) Assignee: SAMSUNG ELECTRONICS CO., LTD., Suwon-si (KR)

(21) Appl. No.: 13/227,309

(22) Filed: Sep. 7, 2011

(30) Foreign Application Priority Data
Sep. 7, 2010 (KR) 10-2010-0087280

(51) Int. Cl. H04W 74/04; H04W 72/04

(52) U.S. Cl. 370/329

(57) ABSTRACT

A scheduling method in a wireless communication system using a dual cell. The method includes determining a scheduling metric value of a user equipment (UE) with respect to each of at least two carriers. The method also includes determining a priority of the UE based on the scheduling metric value, per carrier. The method further includes selecting a UE according to the priority of the UE per carrier. The method also includes determining whether the selected UE has the same priority per carrier, and when the selected UE has the same priority, randomly selecting at least one carrier and allocating a resource to the UE based on the selected carrier.

### CROSS-REFERENCE TO RELATED APPLICATION(S) AND CLAIM OF PRIORITY

The present application is related to and claims priority under 35 U.S.C. §119 to a Korean patent application filed in the Korean Intellectual Property Office on Sep. 7, 2010, and assigned Serial No. 10-2010-0087280, the contents of which is herein incorporated by reference.

### TECHNICAL FIELD OF THE INVENTION

The present invention relates generally to a wireless communication system. More particularly, the present invention relates to a method and an apparatus for scheduling in a wireless communication system using a dual cell.

### BACKGROUND OF THE INVENTION

A Universal Mobile Telecommunication Service (UMTS) system which is a 3rd generation mobile communication system offers consistent services allowing mobile phone or computer users to transmit packet based text, digitized audio or video, and multimedia data at a high rate anywhere in the world. Particularly, the UMTS system supports a High Speed Downlink Packet Access (HSDPA) scheme to further enhance packet transmission performance in the DownLink (DL) communication. To support more stable high-speed data transmission, the HSDPA supports Adaptive Modulation and Coding (AMC), Hybrid Automatic Retransmission reQuest (HARQ), and the like. The modulation scheme employs one of Quadrature Phase Shift Keying (QPSK), 16 Quadrature Amplitude Modulation (QAM), and 64QAM. The AMC technique determines a modulation scheme and a coding scheme of a data channel according to a channel state between a cell and a user and thus raises use efficiency of the whole cell.

The HSDPA system adopts an additional carrier to enhance the performance for frequency selectivity and multiuser diversity. Hereinafter, such a system is referred to as a dual cell or Dual-Carrier (DC)-HSDPA system. On account of the DC-HSDPA system adopted, it is desirable to develop an effective scheduling algorithm for the DC-HSDPA system.

A conventional Proportional Fairness (PF) scheduling is applied to the DC-HSDPA system as expressed in Equation 1.

$$\begin{matrix}{I}^{*} = arg max {\prod }_{i ∈ {U}_{S}} ( 1 + \frac{{\sum }_{j = 1}^{2} {\sum }_{k = 1}^{{K}_{j} ( t )} {x}_{i , j , k} {r}_{i , j , k} ( t )}{( {t}_{c} - 1 ) \overline{{R}_{i} ( t )}} ) & [ Eqn . 1 ] \\ {\sum }_{k = 1}^{{K}_{j} ( t )} {x}_{i , j , k} \leq {N}_{i , j} ( t ) , & i ) \\ {\sum }_{i ∈ {U}_{s}} {\sum }_{k = 1}^{{K}_{j} ( t )} {x}_{i , j , k} \leq {K}_{j} ( t ) , & ii ) \\ {\sum }_{i ∈ {U}_{s}} {\sum }_{k = 1}^{{K}_{j} ( t )} {x}_{i , j , k} {p}_{i , j , k} \leq {P}_{j}^{max} & iii ) \\ {x}_{i , j , k} = \{ 0 , 1 \} , where j = 1 , 2 & iv )\end{matrix}$$

In Equation 1, N denotes the total number of carriers, x_{i,j,k} denotes an indication function (1 when the k-th code is allocated to the carrier j of the i-th User Equipment (UE), and otherwise, 0), Uₛ denotes a UE set in the scheduling, N_{i,j}(t) denotes the number of codes used by the i-th UE in the carrier j at a scheduling time t, Kⱼ(t) denotes the maximum number of codes available in the carrier j at the scheduling time t (e.g., 15 in the HSDPA system), p_{i,j,k} denotes a power allocated to the k-th code used by the i-th UE in the carrier j, t_{c} denotes a window size, and Pⱼ^{max} denotes a maximum power allocable to the carrier j.

Herein, a base station (or an eNode) selects a plurality of UEs and a carrier pair for maximizing the PF metric I* of Equation 1.

In situations associated with full buffer traffic, that is, when a resource (subcarrier, code, and power) is allocated to one UE, it is similar to a single carrier HSDPA scheduling which allocates a UE of the greatest PF metric value per carrier.

However, in situations associated with non-full buffer traffic, that is, when one UE does not use all of the codes or when both of two carriers are used and only one carrier resource is used according to the buffer quantity, the carrier selected affects the determination of the next priority. Hence, since the PF metric summation or the throughput performance is affected, it is necessary to set a maximum value by applying every given UE combination and comparing the PF metric summation for the optimum scheduling.

As discussed above, since the current scheduling algorithm applied to the system is optimized by considering only the single carrier, it is very inefficient to apply the existing algorithm to the DC-HSDPA system.

In this regard, a scheduling method and apparatus for achieving effective load balancing between the dual carriers are demanded.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide scheduling method and apparatus in a wireless communication system using a dual cell.

Another aspect of the present invention is to provide a carrier selection method and apparatus of a user equipment when a DC-HSDPA system uses dual-carrier.

Yet another aspect of the present invention is to provide a method and an apparatus for reducing calculations in PF scheduling in a wireless communication system using a dual cell.

According to one aspect of the present invention, a scheduling method in a wireless communication system using a dual cell includes determining a scheduling metric value of a User Equipment (UE) with respect to each of at least two carriers. The method also includes determining a priority of the UE based on the scheduling metric value, per carrier. The method further includes selecting a UE according to the priority of the UE per carrier. The method also includes determining whether the selected UE has the same priority per carrier, and when the selected UE has the same priority, randomly selecting at least one carrier and allocating a resource to the UE based on the selected carrier.

According to another aspect of the present invention, a scheduling method in a wireless communication system using a dual cell includes determining a scheduling metric value of a UE with respect to each of at least two carriers. The method also includes selecting a carrier corresponding to the greatest scheduling metric value of the UE by comparing the scheduling metric per carrier of the UE. The method further includes sorting UEs using the selected carriers based on a priority. The method also includes allocating a resource to the UE using the selected carrier according to the priority of the UE.

According to yet another aspect of the present invention, a scheduling method in a wireless communication system using a dual cell includes determining a scheduling metric value of a UE with respect to each of at least two carriers. The method also includes sorting a scheduling metric value of the UE regardless of the carriers. The method further includes allocating a resource to a corresponding UE based on a sort order according to the scheduling metric value of the UE. The allocating of the resource to the corresponding UE based on the sort order according to the scheduling metric value of the UE includes determining whether there is an available resource in a current order based on a corresponding carrier, and allocating the resource when there is the available resource, and when there is no available resource, determining whether there is an available resource in a next order based on the corresponding carrier.

According to still another aspect of the present invention, an apparatus of a base station in a wireless communication system using a dual cell includes a scheduler configured to determine a scheduling metric value of a User Equipment (UE) with respect to each of at least two carriers. The scheduler is also configured to determine a priority of the UE based on the scheduling metric value per carrier, select a UE according to the priority of the UE per carrier, determine whether the selected UE has the same priority per carrier, and when the selected UE has the same priority, randomly select at least one carrier and allocate a resource to the UE based on the selected carrier.

According to a further aspect of the present invention, an apparatus of a base station in a wireless communication system using a dual cell includes a scheduler configured to determine a scheduling metric value of a UE with respect to each of at least two carriers, select a carrier corresponding to the greatest scheduling metric value of the UE by comparing the scheduling metric per carrier of the UE, sort UEs using the selected carriers based on a priority, and allocate a resource to the UE using the selected carrier according to the priority of the UE.

According to a further aspect of the present invention, an apparatus of a base station in a wireless communication system using a dual cell includes a scheduler configured to determine a scheduling metric value of a UE with respect to each of at least two carriers, sort a scheduling metric value of the UE regardless of the carriers, and allocate a resource to a corresponding UE based on a sort order according to the scheduling metric value of the UE. To allocate the resource to the corresponding UE based on the sort order according to the scheduling metric value of the UE, the scheduler determines whether there is an available resource in a current order based on a corresponding carrier, allocates the resource when there is the available resource, and determines whether there is an available resource in a next order based on the corresponding carrier when there is no available resource.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a flowchart of a scheduling method in a wireless communication system using a dual cell according to one embodiment of the present invention;

FIG. 2 is a flowchart of a scheduling method in the wireless communication system using the dual cell according to a second embodiment of the present invention;

FIG. 3 is a flowchart of a scheduling method in the wireless communication system using the dual cell according to a third embodiment of the present invention; and

FIG. 4 is a block diagram of a base station for scheduling in the wireless communication system using the dual cell according to an embodiment of the present invention.

Throughout the drawings, like reference numerals will be understood to refer to like parts, components and structures.

### DETAILED DESCRIPTION OF THE INVENTION

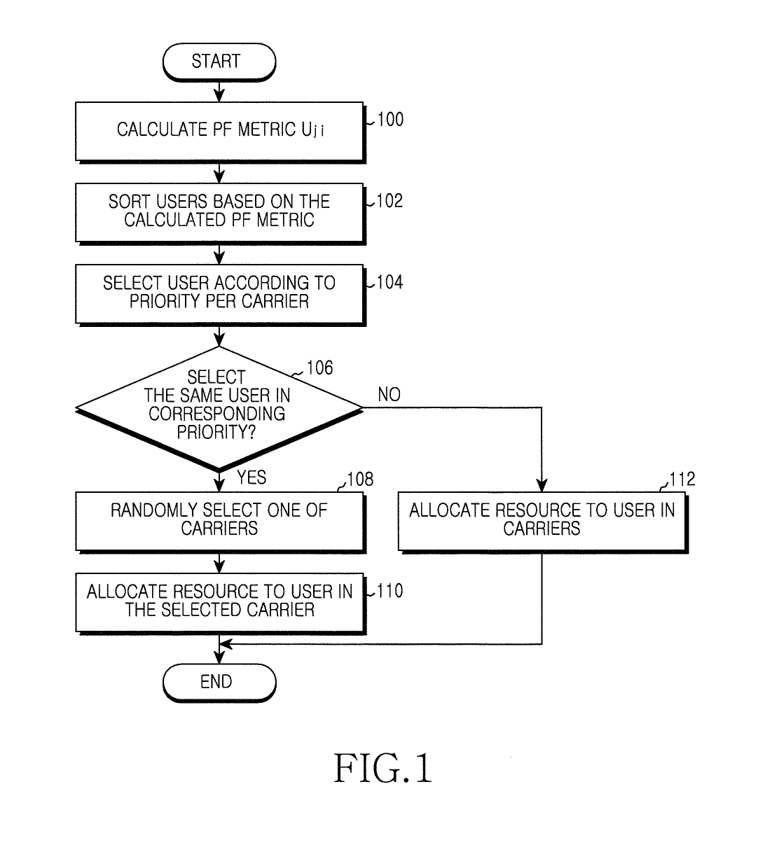

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system.

Preferred embodiments of the present invention will be described herein below with reference to the accompanying drawings. In the following description, well-known functions or constructions are not described in detail since they would obscure the invention in unnecessary detail. Terms described below, which are defined considering functions in the present invention, may be different depending on user and operator's intention or practice. Therefore, the terms should be defined on the basis of the disclosure throughout this specification.

Exemplary embodiments of the present invention provide a method and an apparatus for scheduling in a wireless communication system using a dual cell.

Downlink communication between a base station and a User Equipment (UE) is conducted through two carriers using 5 MHz bandwidth. Each carrier can use fifteen (15) codes and determines a data rate based on a preset table. The data rate is determined by taking account of one or more Channel Quality Indicators (CQI), usable power, the number of the remaining codes, and the like. The codes and the power are limited. That is, when there are no usable codes and the allocable power remains or when there are usable codes and the allocable power is absent, the resource may not be allocated to the UE.

When the actual Dual-Carrier (DC)-High Speed Downlink Packet Access (HSDPA) scheduling selects the carrier of the UE separately from a Proportional Fairness (PF) metric, the resource amount usable by the next UE changes. Accordingly, the conventional method cannot obtain sufficient diversity gain according to carrier addition. For example, when the UE of the same propriety in two carriers can be serviced using only one carrier (e.g., Voice over Internet Protocol (VoIP) service), the carrier selected varies the system throughput, the number of the serviced UEs, or the PF metric sum value. Hence, the conventional scheduling method, which does not jointly use the two-carrier information, is subject to inefficient scheduling because it cannot reflect dual carrier scheduling characteristics.

In this respect, the present invention applies a new carrier selection algorithm to the joint scheduling by considering a DC-HSDPA system.

A full search scheme which searches for the optimized combination by applying every UE combination uses a complexity (comparison) of 2N*log (N)+2N. To avoid this complexity, the present invention provides a method for maintaining the PF metric summation as close as possible to the maximum value and reducing the complexity.

FIG. 1 is a flowchart of a scheduling method in a wireless communication system using the dual cell according to one embodiment of the present invention.

Referring to FIG. 1, the base station calculates the PF metric U_{j,i} for the PF scheduling in block 100. Herein, the present PF scheduling method employs a joint PF scheduling method proposed by Qualcomm. This scheduling method simply extends the conventional Single Carrier (SC)-HSDPA PF scheduling method to the DC-HSDPA. This method performs the joint scheduling between the carriers by sharing the average data rate of one UE in the PF metric of each carrier. The scheduling metric of each UE is given by Equation 2.

$$\begin{matrix}( {i}^{*} , j ) = {arg max}_{i} \frac{{R}_{i , j}}{{\overline{R}}_{tot , i}} , for ∀ i , j & [ Eqn . 2 ] \\ {R}_{i , j} \text{:} data rate according to the & \\ current CQI for the carrier j of the i \text{-} th UE & \\ {\overline{R}}_{tot , i} \text{:} average data rate of the & \\ i \text{-} th UE transmitted over carriers 1 and 2 & \end{matrix}$$

R̅_{tot,i} is updated based on Equation 3.

R̅_{tot,i}=(1−1/Tc) R̅_{tot,i}+1/Tc(R_{1,i}+R_{2,i}), for ∀i [Eqn. 3]

In block 102, the base station sorts UEs based on the calculated PF metric U_{i,j}. For example, it is assumed that the UEs are sorted based on Equation 2 as shown in Table 1.

TABLE 1

| | 1st priority | 2nd priority | 3rd priority | 4th priority | . . . |
|---|---|---|---|---|---|
| carrier 1 | U₅₁ = 10 | U₂₁ = 9 | U₄₁ = 8 | U₁₁ = 3 | . . . |
| carrier 2 | U₄₂ = 7 | U₂₂ = 6 | U₁₂ = 4 | U₆₂ = 2 | . . . |

U_{i,j}, denotes the PF metric value of the i-th UE in the carrier j.

In block 104, the base station selects the UE in the corresponding priority per carrier. For example, the base station selects the fifth UE in the first priority of the carrier 1, the second UE in the second priority of the carrier 1, the fourth UE in the third priority of the carrier 1, and the first UE in the fourth priority of the carrier 1. Likewise, the base station selects the fourth UE in the first priority of the carrier 2, the second UE in the second priority of the carrier 2, the first UE in the third priority of the carrier 2, and the sixth UE in the fourth priority of the carrier 2.

Herein, when one UE (i.e., the second UE) has the same priority for the carrier 1 and the carrier 2 like the second priority of the carrier 1 and the carrier 2 in Table 1, the full buffer traffic model can use both of the two carriers and thus has no problem at all. However, the non-full buffer model selects one of the two carriers when data of the buffer is transmittable using only one carrier as the resource.

In block 106, the base station determines whether the same user is selected in the corresponding priority. When the same user is selected in the corresponding priority, the base station randomly selects only one of the carriers allocated to one UE in the corresponding priority in block 108. For example, when the second UE has the same priority for the carrier 1 and the carrier 2 in the second priority, the base station randomly selects one of the carrier 1 and the carrier 2.

In block 110, the base station transmits data by allocating the resource (the power, the code, and the like) to the UE based on the selected carrier. In so doing, the base station can allocate the unselected carrier to other UEs or utilize the unselected carrier for another purpose.

By contrast, when the same user is not selected in the corresponding priority in block 106, the base station allocates the resource to the UE for the respective carriers in block 112. For example, in the first priority, the carrier 1 is allocated to the fifth UE and the carrier 2 is allocated to the fourth UE. In the third priority, the carrier 1 is allocated to the fourth UE and the carrier 2 is allocated to the first UE. In the fourth priority, the carrier 1 is allocated to the first UE and the carrier 2 is allocated to the sixth UE.

Next, the base station finishes this process.

As stated above, since the value R̅_{tot,i} reflects the data rate used in two carriers, the PF scheduling method is closer to the optimized PF scheduling, which enhances performance and maximizes the PF metric summation because it can obtain the diversity gain compared to the two-single carrier scheduling. While the PF scheduling method is applicable to the full buffer traffic model without any problems, it may use a criterion for applying to the non-full buffer traffic.

The present invention provides a method for transmitting data by randomly selecting one carrier. Alternatively, when the priority in the carrier 1 and the carrier 2 is predefined, the carrier of the higher priority may be selected. Advantageously, the present scheduling method can fulfill the PF scheduling on the UE of which the same priority does not overlap, without complexity. The random selection of the carrier cannot attain the optimum scheduling result, whereas it can reduce the complexity without the considerable performance degradation. Provided that the number of UEs is N, the complexity is 2N*log (N).

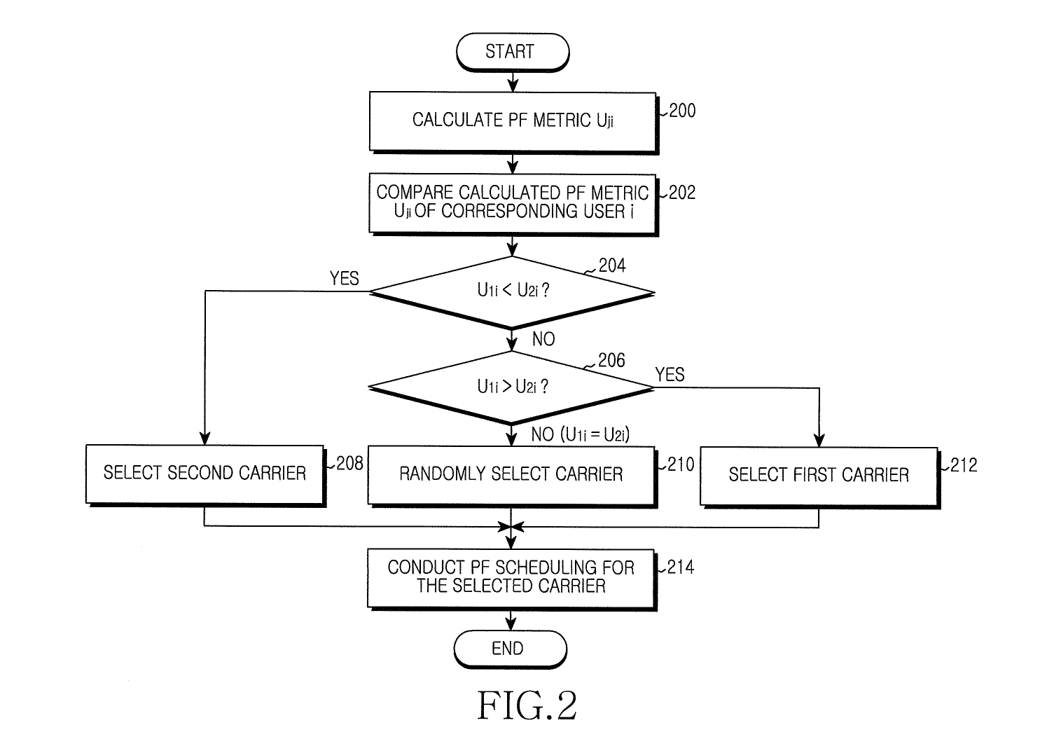

FIG. 2 is a flowchart of a scheduling method in the wireless communication system using the dual cell according to a second embodiment of the present invention.

Referring to FIG. 2, the base station calculates the PF metric U_{j,i} for the PF scheduling in block 200. Herein, the present PF scheduling method employs the joint PF scheduling method proposed by Qualcomm as in FIG. 1 (see Equation 2 and Equation 3).

In block 202, the base station compares the PF metric U_{i,j} of the UE calculated per carrier. When U_{1,i}<U_{2,i} in block 204, the base station selects the carrier 2 for the UE i in block 208. Herein, U_{1,i} is the PF metric value of the i-th UE in the carrier 1 and U_{2,i} is the PF metric value of the i-th UE in the carrier 2.

When U_{1,i} is not less than U_{2,i} in block 204 and U_{1,i}>U_{2,i} in block 208, the base station selects the carrier 1 for the UE i in block 212.

When U_{1,i} is not greater than U_{2,i} in block 206; that is, when U_{1,i}=U_{2,i}, the base station randomly selects one of the carrier 1 and the carrier 2 in block 210. Alternatively, when the priority of the carrier 1 and the carrier 2 is preset, the base station selects the carrier of the higher priority.

That is, when a scheduler of the base station determines the PF metric per carrier of each UE, the UE selects the preferred carrier based on the PF metric. For example, for the fourth UE in Table 1, the carrier 1 is selected since the PF metric value is 7 in the carrier 2 and 8 in the carrier 1. In other words, the PF scheduling is performed for the fourth UE only on the carrier 1 and the fourth UE is excluded from the PF scheduling on the carrier 2.

When the preferred carrier is selected first and then the PF scheduling is carried out, the number of the UEs sorted in each carrier is decreased to thus reduce the comparison complexity. Given the number of the UEs selecting one carrier as a, the complexity is N+a*log 2(a)+(N−a)*log (N−a) (a<=N).

In block 214, the base station performs the PF scheduling for the corresponding UE with respect to the selected carrier.

The conventional base station calculates the PF metric value of each UE per carrier. When the joint scheduling is not applied between the carriers, the PF metric value is sorted based on the size and then the resources are allocated in order per carrier.

In a third embodiment, when the PF metric value is determined per UE and per carrier, the UEs are sorted based on the size of the PF metric value, rather than based on the carrier, regardless of the carrier, and then the allocation is sequentially carried out according to the buffer and the remaining resource. Thus, the scheduling can be achieved by approaching the PF metric summation value to the maximum value without increasing the complexity.

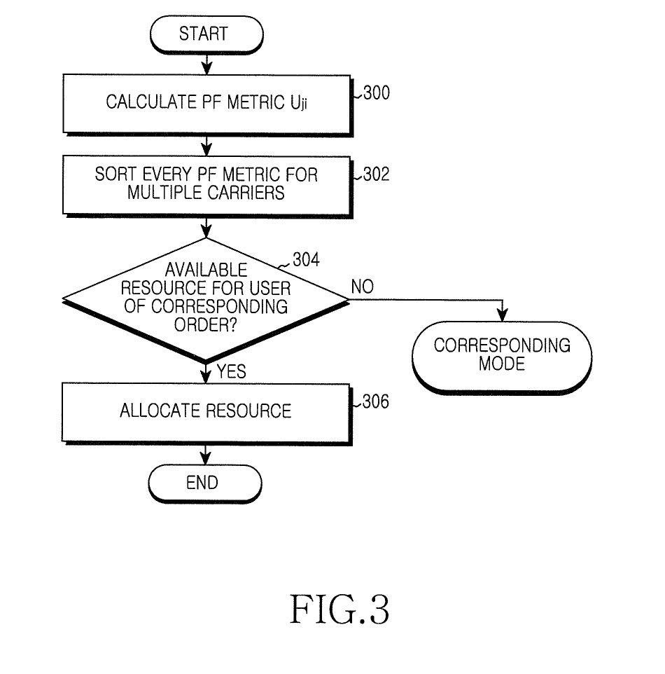

FIG. 3 is a flowchart of the scheduling method in the wireless communication system using the dual cell according to a third embodiment of the present invention.

Referring to FIG. 3, the base station calculates the PF metric U_{j,i} for the PF scheduling in block 300. Herein, the present PF scheduling method employs the joint PF scheduling method proposed by Qualcomm as in FIG. 1 (see Equation 2 and Equation 3).

In block 302, the base station sorts the PF metric values U_{j,i} with respect to the plurality of the carriers. When the UE determines the PF metric values U_{j,i} as shown in Table 1, they are sorted as U51→U21→U41→U42→U22→U21→U11→U62→ . . . .

In block 304, the base station checks whether there is the available resource for the UE based on the sort order. When there is the available resource, the base station allocates the corresponding resource in block 306. When there is no available resource, the base station enters the corresponding mode.

In the corresponding mode, when there is no available resource of the corresponding UE in the current order, the base station determines whether there is the available resource of the corresponding UE in the next order.

For example, the fourth UE has the third priority in the carrier 1 with the PF metric value of 8 and the highest priority in the carrier 2 with the PF metric value of 7 in Table 1. While the conventional PF scheduling derives the PF metric of each carrier by sharing the average value, the PF scheduling is independently conducted per carrier when the same priority does not take place. Hence, the fourth UE is allocated the resource through the carrier 2. Even when the fourth UE obtains the scheduling opportunity according to the priority of the carrier 1 to transmit all of the data based on the buffer state, the UE of the next priority gains the transmission opportunity because there is no data remaining in the buffer.

By contrast, in the third embodiment, each UE is allocated the resource according to the PF metric regardless of the carrier as stated above. That is, based on the scheduling order by considering only the fourth UE in the fourth priority, the resources are allocated in order of U51→U21→U41→U42→U22→U12→ . . . . When the available resource remains in the carrier 1, the scheduling considers the U41, which has the third priority in the carrier 1, over the U42 (the first priority of the carrier 2) as shown in the arranged scheduling order. This approach alters the scheduling order compared to the conventional scheduling method, whereas it is more optimal in terms of the PF scheduler, which maximizes the PF metric summation. Since the resources are allocated based on the PF metric value even with the same priority, there is no need to compare the state of the next UE and thus this approach can attain the gain also in the complexity. The complexity in the third embodiment, which merely sorts the PF metric of the UEs, is 2N*log(2N).

The number of the comparisons is compared between the full search method, the method of the first embodiment, the method of the second embodiment, and the method of the third embodiment as shown in Table 2 and Table 3.

TABLE 2

| Scheduling | |
|---|---|
| approach | Number of Comparison |
| Full search | N * log2 (N) + 2\hat{ }N′ N′ = min (N, # of OVSF codes * 2) |
| first embodiment | 2N * log2 (N) |
| second | N + a * log2(a) + (N − a) * log2 (N − a) |
| embodiment | |
| third embodiment | 2N * log2 (2N) |

TABLE 3

| Number of Users | 10 | 20 | 30 | 40 | 50 | 60 | 70 | 80 | 90 | 100 |
|---|---|---|---|---|---|---|---|---|---|---|
| Full search | 1090 | 1E+06 | 1E+09 | 1E+09 | 1E+09 | 1E+09 | 1E+09 | 1E+09 | 1E+09 | 1E+09 |
| first | 66 | 172 | 294 | 425 | 564 | 708 | 858 | 1011 | 1168 | 1328 |
| embodiment | | | | | | | | | | |
| second | 33 | 86 | 147 | 212 | 282 | 354 | 429 | 505 | 584 | 664 |
| embodiment | | | | | | | | | | |
| third | 86 | 212 | 354 | 505 | 664 | 828 | 998 | 1171 | 1348 | 1528 |
| embodiment | | | | | | | | | | |

As shown in Table 3, the present algorithm can greatly reduce the comparison complexity, compared to the full search.

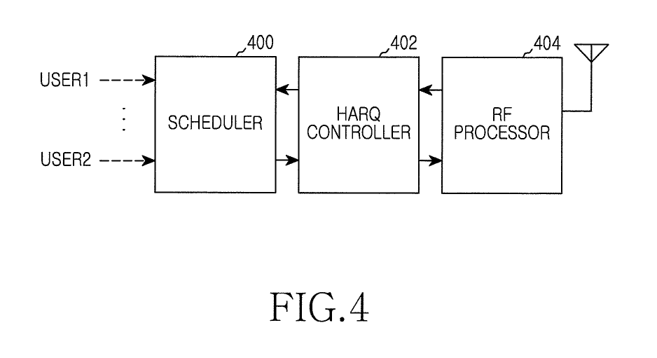

FIG. 4 is a block diagram of the base station for scheduling in the wireless communication system using the dual cell according to an embodiment of the present invention.

Referring to FIG. 4, the base station includes a scheduler 400 for determining the priority of the plurality of the UEs to transmit packet data, an HARQ controller 402 for retransmitting data by detecting error of the transmitted packet data, and a Radio Frequency (RF) processor 404 for converting the packet data to transmit to an RF signal and sending the RF signal, or receiving an RF signal from the UE and transferring the RF signal to the HARQ controller 402.

According to one embodiment, the scheduler 400 determines the PF metric value of the UE for each carrier (see Equation 2), determines the priority of the UE per carrier based on the PF metric value, and selects the UE per carrier according to the priority of the UE. The scheduler 400 determines per carrier whether the selected UE is the same. When the selected UE is the same, the scheduler 400 randomly selects at least one carrier and allocates the resource to the UE based on the selected carrier. When the selected UE is the same, the scheduler 400 allocates the resources to the selected UE based on the priority per carrier.

According to another embodiment, the scheduler 400 determines the PF metric value of the UE for each carrier, selects the carrier by comparing the scheduling metric per carrier of the UE, and allocates the resource to the UE based on the selected carrier. For example, when the scheduling metric of the UE for the first carrier is greater than the scheduling metric of the UE for the second carrier, the scheduler 400 selects the first carrier. When the scheduling metric of the UE for the first carrier is smaller than the scheduling metric of the UE for the second carrier, the scheduler 400 selects the second carrier. When the scheduling metric of the UE for the first carrier is equal to the scheduling metric of the UE for the second carrier, the scheduler 400 randomly selects the carrier.

According to yet another embodiment, the scheduler 400 determines the PF metric value of the UE for each carrier, sorts the PF metric value of the UE regardless of the carrier, and allocates the resource to the corresponding UE based on the sorted order according to the PF metric value of the UE. For example, the scheduler 400 determines whether there is the available resource based on the corresponding carrier in the current order. When detecting the available resource, the scheduler 400 allocates the resource. When detecting no available resource, the scheduler 400 determines whether there is the available resource based on the corresponding carrier in the next order.

The HARQ controller 402 receives, from the scheduler 400, buffer identification information (queue ID) indicating the buffer storing the transmit data of the scheduler 400, the ACK/NACK information indicating error in the previously transmitted data, and information (ARQ channel number) indicating the number of the available channels for the retransmission. Based on the information received from the scheduler 400, the HARQ controller 402 retransmits the data by detecting the presence or the absence of the error of the transmitted packet data. The HARQ controller 402 efficiently combines the existing receive data and the retransmitted receive data and performs the decoding by applying not only the retransmission but also chase combination or Incremental Redundancy (IR).

Under control of the HARQ controller 402, the RF processor 404 transmits the user data scheduled by the scheduler 400. The RF processor 404 complies with Orthogonal Frequency Division Multiplexing (OFDM)/Orthogonal Frequency Division Multiple Access (OFDMA) communication scheme.

As set forth above, the wireless communication system using the dual call adopts the carrier selection algorithm by considering the non-full buffer traffic, and thus reduces the PF scheduling calculation.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A scheduling method in a wireless communication system using a dual cell, the method comprising:
determining a scheduling metric value of a user equipment (UE) with respect to each of at least two carriers;
determining a priority of the UE based on the scheduling metric value, per carrier;
selecting a UE according to the priority of the UE per carrier; and
determining whether the selected UE has the same priority per carrier, and when the selected UE has the same priority, randomly selecting at least one carrier and allocating a resource to the UE based on the selected carrier.

2. The scheduling method of claim 1, further comprising:
when the selected UE does not have the same priority, allocating the resource to the selected UE according to the priority per carrier.

3. The scheduling method of claim 1, wherein the scheduling is based on a non-full buffer traffic model for transmitting data of a buffer using only one carrier.

4. The scheduling method of claim 1, wherein the scheduling is a proportional fairness (PF) scheduling.

5. The scheduling method of claim 4, wherein the PF scheduling is based on the following equation:
$$( {i}^{*} , j ) = {arg max}_{i} \frac{{R}_{i , j}}{{\overline{R}}_{tot , i}} , for ∀ i , j$$
R_{i,j}: data rate according to the current CQI for the carrier j of the i-th UE.
R̅_{tot,i}: average data rate of the i-th UE transmitted over carriers 1 and 2

6. A scheduling method in a wireless communication system using a dual cell, the method comprising:
determining a scheduling metric value of a user equipment (UE) with respect to each of at least two carriers;
selecting a carrier corresponding to the greatest scheduling metric value of the UE by comparing the scheduling metric per carrier of the UE;
sorting UEs using the selected carriers based on a priority; and
allocating a resource to the UE using the selected carrier according to the priority of the UE.

7. The scheduling method of claim 6, wherein the scheduling is based on a non-full buffer traffic model for transmitting data of a buffer using only one carrier.

8. The scheduling method of claim 6, wherein the scheduling is a proportional fairness (PF) scheduling.

9. A scheduling method in a wireless communication system using a dual cell, the method comprising:
determining a scheduling metric value of a user equipment (UE) with respect to each of at least two carriers;
sorting a scheduling metric value of the UE regardless of the carriers; and
allocating a resource to a corresponding UE based on a sort order according to the scheduling metric value of the UE,
wherein the allocating of the resource to the corresponding UE based on the sort order according to the scheduling metric value of the UE comprises:
determining whether there is an available resource in a current order based on a corresponding carrier, and allocating the resource when there is the available resource; and
when there is no available resource, determining whether there is an available resource in a next order based on the corresponding carrier.

10. The scheduling method of claim 9, wherein the scheduling is based on a non-full buffer traffic model for transmitting data of a buffer using only one carrier.

11. An apparatus of a base station in a wireless communication system using a dual cell, the apparatus comprising:
a scheduler configured to determine a scheduling metric value of a user equipment (UE) with respect to each of at least two carriers, determine a priority of the UE based on the scheduling metric value per carrier, select a UE according to the priority of the UE per carrier, determine whether the selected UE has the same priority per carrier, and when the selected UE has the same priority, randomly select at least one carrier and allocate a resource to the UE based on the selected carrier.

12. The apparatus of claim 11, wherein, when the selected UE does not have the same priority, the scheduler allocates the resource to the selected UE according to the priority per carrier.

13. The apparatus of claim 11, wherein the scheduling is based on a non-full buffer traffic model for transmitting data of a buffer using only one carrier.

14. The apparatus of claim 1, wherein the scheduling is a proportional fairness (PF) scheduling.

15. The apparatus of claim 14, wherein the PF scheduling is based on the following equation:
$$( {i}^{*} , j ) = {arg max}_{i} \frac{{R}_{i , j}}{{\overline{R}}_{tot , i}} , for ∀ i , j$$
R_{i,j}: data rate according to the current CQI for the carrier j of the i-th UE.
R̅_{tot,i}: average data rate of the i-th UE transmitted over carriers 1 and 2

16. An apparatus of a base station in a wireless communication system using a dual cell, the apparatus comprising:
a scheduler configured to determine a scheduling metric value of a user equipment (UE) with respect to each of at least two carriers, select a carrier corresponding to the greatest scheduling metric value of the UE by comparing the scheduling metric per carrier of the UE, sort UEs using the selected carriers based on a priority, and allocate a resource to the UE using the selected carrier according to the priority of the UE.

17. The apparatus of claim 16, wherein the scheduling is based on a non-full buffer traffic model for transmitting data of a buffer using only one carrier.

18. The apparatus of claim 16, wherein the scheduling is a proportional fairness (PF) scheduling.

19. An apparatus of a base station in a wireless communication system using a dual cell, the apparatus comprising:
a scheduler configured to determine a scheduling metric value of a User Equipment (UE) with respect to each of at least two carriers, sort a scheduling metric value of the UE regardless of the carriers, and allocate a resource to a corresponding UE based on a sort order according to the scheduling metric value of the UE,
wherein, to allocate the resource to the corresponding UE based on the sort order according to the scheduling metric value of the UE, the scheduler determines whether there is an available resource in a current order based on a corresponding carrier, allocates the resource when there is the available resource, and determines whether there is an available resource in a next order based on the corresponding carrier when there is no available resource.

20. The apparatus of claim 19, wherein the scheduling is based on a non-full buffer traffic model for transmitting data of a buffer using only one carrier.
